(19) United States
(12) Patent Application Publication
(10) Pub. No.: US 2015/0284860 A1
(43) Pub. Date: Oct. 8, 2015

(54) PROTECTION OF STEEL REINFORCED CONCRETE ELEMENTS

(71) Applicants: Gareth GLASS, Stanffordshire (GB); Nigel DAVISON, Derbyshire (GB); Adrian ROBERTS, Nottinghamshire (GB); Mattew GLASS, Staffordshire (GB)

(72) Inventors: Gareth Glass, Lichfield (GB); Nigel Davison, Swadlincote (GB); Adrian Roberts, Nottingham (GB); Matthew Glass, Lichfield (GB)

(21) Appl. No.: 14/436,898

(22) PCT Filed: Oct. 18, 2013
(86) PCT No.: PCT/GB2013/052734

§ 371 Date: Apr. 19, 2015

Related U.S. Application Data
(60) Provisional application No. 61/715,373, filed on Oct. 18, 2012.

(51) Int. Cl. C23F 13/04; H01M 12/08; C23F 13/10

(52) U.S. Cl. CPC C23F 13/04; C23F 13/10; H01M 12/08; C23F 2201/02; C23F 2213/21

(57) ABSTRACT

A method of protecting steel in a reinforced concrete element is disclosed. The reinforced concrete of the element contains an electrolyte. The method involves providing a primary anode, which is a sacrificial anode, and providing a secondary anode, which is connected to a positive terminal of at least one source of direct current, ‘DC’, power. The primary anode and secondary anode are arranged to have an ionic connection with the steel in the reinforced concrete element via the electrolyte. The primary anode is connected to the steel in the reinforced concrete element using an electron conductor. The negative terminal of the source of DC power is connected to the steel in the reinforced concrete element using an electron conductor.

The present application is a national stage entry under the provisions of 37 CFR 1.371 from PCT/GB2013/052734 which has an international filing date of 18 Oct. 2013 which claims priority to U.S. Provisional Application Ser. No. 61/715,373 filed 18 Oct. 2012, the specifications of which are incorporated in their entirety herein.

### BACKGROUND

The present invention relates to electrochemical protection of steel in reinforced concrete construction and, in particular, to the use of anode assemblies in treating steel corrosion in corrosion damaged steel reinforced concrete elements making up a concrete structure.

Atmospherically exposed steel reinforced concrete structures suffer from corrosion induced damage mainly as the result of carbonation or chloride contamination of the concrete. As the steel reinforcement corrodes, it produces by-products that occupy a larger volume than the steel from which the products are derived. As a result, expansion occurs around reinforcing steel bars. This causes cracking and delamination of the concrete cover of the steel. Typical repairs involve removing this patch of corrosion damaged concrete from the concrete structure(s). It is good practice to expose corroding steel, in the area of damage, and to remove the concrete behind the corroding steel. The concrete profile is then restored with a compatible cementitious repair concrete or mortar. The concrete then consists of the “parent” concrete (i.e., the remaining original concrete) and the “new” patch repair material

The parent concrete, adjacent to the repair area, is typically likely to suffer from some of the same chloride contamination or carbonation that caused the original corrosion damage. It is to be appreciated that steel corrosion still remains a risk in the parent concrete. Corrosion in concrete is an electrochemical process and electrochemical treatments have been used to treat this corrosion risk.

Established electrochemical treatments include cathodic protection, chloride extraction and re-alkalisation. These are classed as either permanent or temporary treatments. In a permanent treatment the treatment must be sustained to achieve the protective effect on which the treatment is based. A permanent treatment may for example be based on achieving a current induced negative steel potential shift in which a protection current must be sustained to achieve a negative steel potential shift. By contrast temporary treatments rely on a protective effect that persists after the treatment has ended and may for example be based on removing chloride or restoring pH.

Electrochemical treatments may also be classed as either impressed current or galvanic (sacrificial) treatments. In impressed current electrochemical treatments, an anode is connected to the positive terminal and the steel is connected to the negative terminal of an external source of DC power. An example of an impressed current anode is an activated titanium electrode. An anode is an electrode supporting a substantial oxidation reaction and the oxidation reaction induced by an external source of DC power on an activated titanium electrode turns water into oxygen and hydrogen ions (acid).

In galvanic electrochemical treatments, the protection current is provided by one or more sacrificial anodes that are connected to the steel. Sacrificial anodes are electrodes comprising metals less noble than steel (more negative than) with the main anodic reaction being the oxidation of a sacrificial metal element. The natural potential difference between the sacrificial anode and the steel drives a protection current when the sacrificial anode is connected to the steel. Sacrificial anode assemblies are self-powered assemblies. The protection current flows as ions from the sacrificial anode into the parent concrete and to the steel, and returns as electrons through the steel and an electron conductor to the sacrificial anode. The direction of current flow is conventionally expressed as the direction of movement of positive charge.

Sacrificial anodes for concrete structures may be divided into discrete or continuous anodes. Discrete anodes are individually distinct elements that contact a concrete surface area that is substantially smaller than the surface area of the concrete covering the protected steel. The anode elements are normally connected to each other through a conductor that is not intended to be a sacrificial anode and are normally embedded within cavities in the concrete. A discrete anode assembly diameter is typically less than 50 mm

Discrete sacrificial anode systems generally include an anode, a supporting electrolyte and a backfill. An activating agent is often included to maintain sacrificial anode activity. The backfill provides space to accommodate the products of anodic dissolution and prevent disruption of the surrounding hardened concrete. Discrete sacrificial anodes have the advantage that it is relatively easy to achieve a durable attachment between the anode and the concrete structure by embedding the anodes within cavities formed in the concrete. Compact discrete anodes may be located in drilled holes in the concrete, typically less than 50 mm in diameter and less than 200 mm long.

Concrete as an environment presents its own unique set of challenges for electrochemical treatments. Anode assemblies that are embedded within concrete must be dimensionally stable as concrete is a rigid material that does not tolerate embedded expanding assemblies. Anode activating agents are specific to concrete or need to be arranged in a way that would present no corrosion risk to the neighboring steel. Anodes are located relatively close to the steel in the concrete. Protection criteria for atmospherically exposed concrete differ from the criteria used in other environments and some electrochemical treatments are unique to concrete. This is partly because steel is normally passive in uncontaminated, alkaline concrete.

Reinforced concrete structures typically comprise various elements. Examples include columns, beams, slabs, joints, and abutments. Anodes systems for electrochemical treatments will typically be divided into zones which, for example, depend on the structural element, the density of steel in the concrete, and the aggressive nature of the local environment.

One problem with the use of sacrificial anodes in galvanic treatments is that the power to arrest an active corrosion process on the steel in concrete is limited by the voltage difference between the sacrificial anode and the steel. This problem is greatest for compact discrete sacrificial anode systems where large currents are required from relatively small anodes to protect relatively large surfaces of the steel. A compact discrete anode will typically deliver current into an area of anode surface that is one tenth to one fiftieth of the area of the steel that the anode is expected to protect.

GB 2426008 (U.S. Pat. No. 7,909,982) discloses a new basis for protecting steel in concrete that relies on a process described by the phrase “pit re-alkalisation”. A pit re-alkalisation process arrests active corrosion by restoring a high pH at the corroding sites.

It is an objective of this invention to provide improved methods and assemblies for treating concrete to address or at least ameliorate the problem of the corrosion of steel used for reinforcing the concrete. The exemplary implementations of the invention described herein have particular relevance to what is described in U.S. Pat. No. 7,909,982 and has the potential to provide improvements over the methods and assemblies disclosed in U.S. Pat. No. 8,273,239, U.S. Pat. No. 8,211,289, U.S. Pat. No. 7,704,372 and U.S. Pat. No. 7,909,982.

### SUMMARY

Disclosed herein is a method of protecting steel in a reinforced concrete element, the reinforced concrete of the element containing an electrolyte that includes the steps of providing at least one primary anode, wherein the at least one primary anode is a sacrificial anode. the method also comprises the steps of providing at least one secondary anode, wherein the at least one secondary anode is connected to a positive terminal of at least one source of direct current, ‘DC’, power; arranging the at least one primary anode and at least one secondary anode to have an ionic connection with the steel in the reinforced concrete element via the electrolyte; connecting the at least one primary anode to the steel in the reinforced concrete element using an electron conductor; and connecting the negative terminal of the source of DC power to the steel in the reinforced concrete element using an electron conductor.

Also disclosed is a sacrificial anode reinforced concrete protection assembly for use in the method disclosed herein that includes a sacrificial anode for use as the secondary anode of said method, the sacrificial anode having a first charge capacity; and a cell for use as the source of DC power of said method, the cell having a second charge capacity such that the sacrificial anode is integrated with the cell as a single unit with the sacrificial anode connected to a positive terminal of the cell; and the first charge capacity is greater than the second charge capacity. Also disclosed is a sacrificial anode reinforced concrete protection assembly.

### BRIEF DESCRIPTION OF THE DRAWING

This invention will now be described further with reference, by way of example only, to the drawings in which:

FIG. 1 illustrates the one arrangement of general connections in a protection system for a steel reinforced concrete element;

FIG. 2 illustrates an integrated cell and sacrificial anode assembly wherein the cell is formed on an outer surface of a sacrificial anode and is exposed to air;

FIG. 3 illustrates an integrated cell and sacrificial anode assembly wherein the cell cathode is formed in the center of a sacrificial anode and is exposed to air;

FIG. 4 illustrates another arrangement of an integrated cell and sacrificial anode assembly and is exposed to air;

FIG. 5 illustrates a method of using an integrated cell and sacrificial anode assembly;

FIG. 6 illustrates an integrated cell and sacrificial anode assembly that includes 3 anode elements and an air cathode;

FIG. 7 illustrates an integrated cell and sacrificial anode assembly wherein the cell cathode is located within the assembly and does not require air;

FIG. 8 illustrates another integrated cell and sacrificial anode assembly wherein the assembly includes 3 anode elements and the cell cathode is located within the assembly and the cell cathode does not require air;

FIG. 9 illustrates a cell and sacrificial anode assembly wherein the assembly with 3 anode elements that may be separated into two separate assemblies;

FIG. 10 illustrates another arrangement of a cell and sacrificial anode assembly wherein the assembly with three anode elements that may be separated into two separate assemblies;

FIG. 11 illustrates arrangement using the different and separate assemblies to protect steel in concrete;

FIG. 12 illustrates the another arrangement of general connections in a protection system for a steel reinforced concrete element that includes three anodes;

FIG. 13 illustrates another arrangement using the different and separate assemblies to protect steel in concrete;

FIG. 14 shows the charge delivered to protected steel by a sacrificial anode and the cell voltage of a D sized alkaline cell when the D sized alkaline cell is connected in series with the anode and the steel;

FIG. 15 shows the charge delivered to protected steel by a sacrificial anode and the protection when a D sized alkaline cell is connected in series with the anode and the steel;

FIG. 16 illustrates the construction of a cell and sacrificial anode assembly when the sacrificial anode has substantially more charge than the cell;

FIG. 17 illustrates another arrangement using the different and separate assemblies to protect steel in concrete;

FIG. 18 illustrates another arrangement of general connections in a protection system for a steel reinforced concrete element that uses a more general DC power source; and

FIG. 19 provides a circuit diagram of the arrangement in FIG. 18 to assist in selecting the anode spacing.

It will be appreciated that the combinations of features shown in individual figures and described with reference to specific examples below are purely exemplary. As those skilled in the art will readily understand, specific features of any of the examples described and shown may be used in isolation from the example for which they are specifically disclosed and may be used in combination with features, or a subset of features, of any other specific example to the extent that it is technically feasible.

### DETAILED DESCRIPTION

According to one aspect the invention provides a method of protecting steel in a reinforced concrete element, the reinforced concrete of the element containing an electrolyte, the method comprising: providing at least one primary anode, wherein the at least one primary anode is a sacrificial anode; providing at least one secondary anode, wherein the at least one secondary anode is connected to a positive terminal of at least one source of direct current, ‘DC’, power; arranging the at least one primary anode and at least one secondary anode to have an ionic connection with the steel in the reinforced concrete element via the electrolyte; connecting the at least one primary anode to the steel in the reinforced concrete element using an electron conductor; connecting the negative terminal of the source of DC power to the steel in the reinforced concrete element using an electron conductor. In said arranging step, each of at least one pair of primary anodes may be provided on a different respective side of at least one secondary anode.

In said arranging step, each of at least one pair of primary anodes may be provided on a different respective side of a plurality of secondary anodes.

In said arranging step, each of at least one pair of secondary anodes may be provided on a different respective side of at least one primary anode.

The number of primary anodes provided may be greater than the number of secondary anodes.

A plurality of primary anodes may be provided and a single secondary anode is provided within a region of said reinforced concrete element.

In said arranging step, said at least one primary anode may be spaced from said at least one secondary anode at a distance of no more than substantially 2 meters within a 10% tolerance (preferably no more than substantially 1 meter or no more than substantially 600 mm).

In said arranging step, said at least one primary anode and said at least one secondary anode may be provided at a density of at least one primary anode (preferably at least two primary anodes) and said at least one secondary anode per square meter of a surface of said reinforced concrete.

The method may further comprise connecting each primary anode to the negative terminal of the source of DC power using at least one electron conductor other than the steel.

The reinforced concrete element may comprise an element (e.g. a column, pillar, section or the like) of a larger concrete structure (e.g. a bridge, building, building fa9ade, roadway or the like).

Each said secondary anode may be connected to a positive terminal of a respective source of DC power (e.g. as part of an integrated anode assembly in which said secondary anode and said source of DC power are integrated to form a single unit).

Each said secondary anode may be a sacrificial anode.

A plurality of secondary anodes may be connected to a positive terminal of a single external source of DC power as part of an impressed current system.

According to one aspect the invention provides a sacrificial anode reinforced concrete protection assembly for use in an above method the assembly comprising: a sacrificial anode for use as the secondary anode of said method, the sacrificial anode having a first charge capacity; and a cell for use as the source of DC power of said method, the cell having a second charge capacity; wherein the sacrificial anode is integrated with the cell as a single unit with the sacrificial anode connected to a positive terminal of the cell; and wherein the first charge capacity is greater than the second charge capacity.

According to one aspect the invention provides a sacrificial anode reinforced concrete protection assembly for use in the method of any of claims 1 to 12, the assembly comprising: a sacrificial anode for use as the secondary anode of said method, the sacrificial anode having a first charge capacity; and a cell for use as the source of DC power of said method, the cell having a second charge capacity; wherein the sacrificial anode is integrated with the cell as a single unit with the sacrificial anode connected to a positive terminal of the cell; and wherein the charge capacity of the sacrificial anode is substantially at least 100 kilo-Coulombs within a 10% tolerance.

According to one aspect the invention provides a sacrificial anode reinforced concrete protection assembly for use in an above method, the assembly comprising: a sacrificial anode for use as the secondary anode of said method; and a cell for use as the source of DC power of said method, the cell having a cell anode forming a negative terminal, a cell cathode forming a positive terminal and a cell electrolyte ionically connecting the cell anode and the cell cathode; wherein the sacrificial anode is integrated with the cell as a single unit with the sacrificial anode connected to the positive terminal of the cell; and wherein the cell cathode comprises an air cathode, the air cathode having a first face substantially in contact with the cell electrolyte, and a second face substantially in contact with air.

The cell may comprise a cell anode forming a negative terminal, a cell cathode forming the positive terminal and a cell electrolyte ionically connecting the cell anode and the cell cathode.

According to one aspect the invention provides a sacrificial anode reinforced concrete protection assembly for use in an above method, the assembly comprising: a sacrificial anode for use as the secondary anode of said method; and a cell for use as the source of DC power of said method, the cell having a cell anode forming a negative terminal, a cell cathode forming a positive terminal and a cell electrolyte ionically connecting the cell anode and cell cathode; wherein the sacrificial anode is integrated with the cell as a single unit with the sacrificial anode connected to the positive terminal of the cell; and wherein the cell cathode and the sacrificial anode are spaced away from one another but interconnected using at least one electron conducting wire.

The assembly may comprising a further anode, wherein the further anode is a sacrificial anode; wherein the further anode and the secondary anode are integrated with the cell as a single unit with the secondary anode connected to the positive terminal of the cell.

According to one aspect the invention provides a sacrificial anode reinforced concrete protection assembly comprising: a primary anode, wherein the primary anode is a sacrificial anode; a secondary anode, wherein the secondary anode is a sacrificial anode; and a cell, the cell having a cell anode forming a negative terminal, a cell cathode forming a positive terminal and a cell electrolyte ionically connecting the cell anode and the cell cathode; wherein the primary anode and the secondary anode are integrated with the cell as a single unit with the secondary anode connected to the positive terminal of the cell.

The primary anode may be positioned between the secondary anode and the cell.

The primary anode may be connected to the negative terminal of the cell.

The primary anode and cell anode may be formed from a common piece of sacrificial material.

The primary anode and cell anode may be formed from different pieces of sacrificial material.

The cell cathode may comprises an air cathode, the air cathode having a first face substantially in contact with the cell electrolyte, and a second face substantially in contact with air.

The cell cathode and the sacrificial anode of the secondary anode may be spaced away from one another but interconnected using at least one electron conducting wire.

The secondary anode may have a first charge capacity and the cell may have a second charge capacity wherein the first charge capacity may be greater than the second charge capacity.

The charge capacity of the sacrificial anode may be substantially no less than 1.25 times the charge capacity of the cell within in a 10% tolerance.

The charge capacity of the sacrificial anode may be substantially at least 100 kilo-Coulombs within a 10% tolerance (preferably at least 150 kilo-Coulombs).

Advantages of the above aspects include the advantage that a powered second anode may be used to mitigate any additional corrosion risk when it occurs while sustaining a galvanic protection system.

FIG. 1 is a block diagram showing the general connections in a protection system for a steel reinforced concrete element. Referring to FIG. 1, a sacrificial metal element (Anode A) is connected to the steel to be protected by an electron conducting conductor and by an ionically conducting electrolyte (Electrolyte A). A sacrificial metal element comprises a metal less noble than steel (more electrochemically active than steel), examples of which include zinc, aluminum and magnesium or alloys thereof. Zinc and its alloys are preferred for use in concrete. The sacrificial metal element provides a key component for a sacrificial anode (galvanic anode). The connections through the conductor and electrolyte provide sacrificial cathodic protection (or galvanic protection) to the steel. A protection current (galvanic current) flows to the steel as a result of galvanic action At the start of the treatment or when a higher corrosion risk exists, the protection current may be supplemented or exclusively provided by a battery or cell (Cell in FIG. 1) and a second anode (Anode B in FIG. 1) through an electrolyte (Electrolyte B) to the steel. Electrolyte A and Electrolyte B may be the same electrolyte, for example, the electrolyte found within the pore system of concrete. Anode B is preferably a consumable sacrificial metal element which enhances the voltage that delivers the protection current. However Anode B may alternatively be an inert anode that is not consumed, but is driven by a source of DC power.

When the second anode or any element of the cell, which provides the source of DC power is consumed, current will continue to flow from the first sacrificial metal element via Electrolyte A and/or via Electrolyte B and Electrolyte C to the steel. Electrolyte C may be provided by exposure of a separator between Anode A and Anode B to the environment within concrete as the result of the consumption of Anode B. The cell in FIG. 1 comprises a cell cathode, cell electrolyte and a cell anode. The cell anode may be provided by a distinct part of the first Anode (Anode A), or may be separate and in use, connected to the first sacrificial metal element either directly or indirectly. One cell cathode is an air cathode. Other cathodes such as a Manganese Dioxide cathode and/or the like may also be used. The cell electrolyte may be any conventional cell electrolyte. A typical cell might be a conventional battery, such as a Duracell® DA675N6 1.4V zinc air battery or the like, that has been modified for use in the protection system, for example to increase the anode material available thereby to increase the charge capacity of the cell.

When the cell is delivering 5 mA, the cell voltage may be less than 1.4 V and or even less than 1.0 V. A low cell drive voltage is particularly preferable when Electrolyte A and/or Electrolyte B are present at the same time as this improves the efficiency of use of the second anode (Anode B) when it comprises a sacrificial metal element and the source of DC power when it comprises a cell

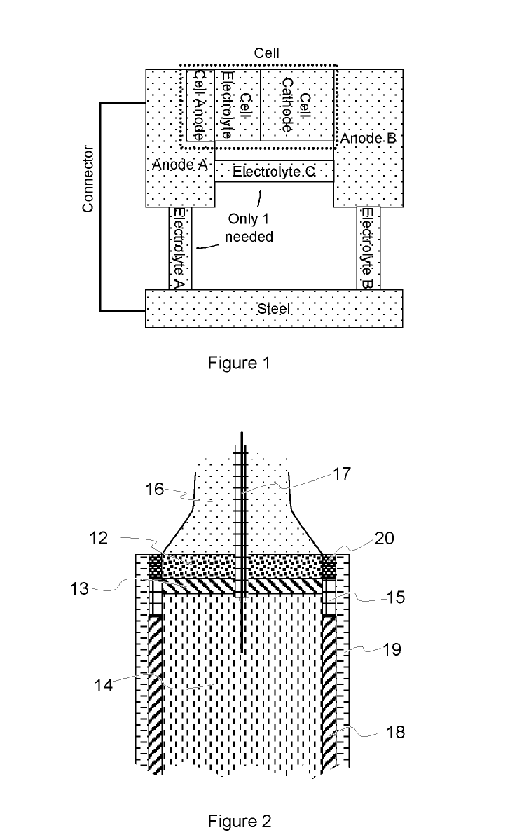

FIG. 2 shows one arrangement of a suitable sacrificial anode assembly. In the arrangement in FIG. 2, the cell is formed by a cathode 12, an electrolyte 13 and one face of a primary anode 14 (or first sacrificial metal element). The primary anode 14 in this example is preferably a compact, discrete sacrificial anode for reinforced concrete construction. It preferably comprises zinc or one of its alloys. The cathode is preferably an air cathode. It may comprise a carbon cloth with PTFE diffusion layers on its air side and layers comprising carbon and/or platinum on its solution side. An insulator 15 preferably seals the electrolyte 13 within the cell and distinguishes a distinct section of the primary anode 14 that acts as a cell anode. The insulator may be arranged to prevent the cell electrolyte from escaping as the cell anode is consumed.

In this example an air channel 16 is provided to promote the diffusion of air to the air side of the cathode 12. The air channel 16 may be a porous breathable fabric. It may, for example be canvas or woven nylon treated with a waterproofing agent. A connector 17 is attached to the primary anode for the purpose of connecting the assembly to the steel. The connector is isolated from the cathode of the cell, by for example using insulation, so that it does not connect to the cell cathode and short out the cell.

Also shown in FIG. 2 is a separator 18, separating the primary anode 14 from a secondary anode 19. In this example the secondary anode would comprise a second sacrificial metal element so that when it is consumed, electrolyte from the concrete can enter the separator and current can flow out from the primary anode to the concrete and to the steel. The secondary anode 19 may be constructed from zinc or one of its alloys suitable for use as a sacrificial anode material in concrete construction. The separator 18 is preferably dry and contains no electrolyte when constructed. It, however, may include an activating agent to activate the primary anode 14 when the secondary anode 19 has been consumed and electrolyte from the concrete enters the separator. An activator suitable for use in concrete construction may be directly applied to the surface of the primary anode or it may be included within the material of the separator 18. The secondary anode 19 is connected to the cell cathode 12 with an electron conducting conductor 20. The secondary anode 19 is also preferably coated with an activating agent. When first used, a current will be driven off the secondary anode using the additional voltage provided by the cell until the secondary anode is consumed. Because of this additional voltage, a higher initial protection current will be delivered to the steel.

A feature of the cell arrangement in FIG. 2 is the cell cathode 12 extends away from the secondary anode such that some sections of the cell cathode are further from the secondary anode than other sections of the cell cathode 12. The cell cathode 12 will typically extend more than 2 mm away from the secondary anode 19 in this arrangement and one section of cell cathode 12 typically spaces another section of cell cathode off the secondary anode 19.

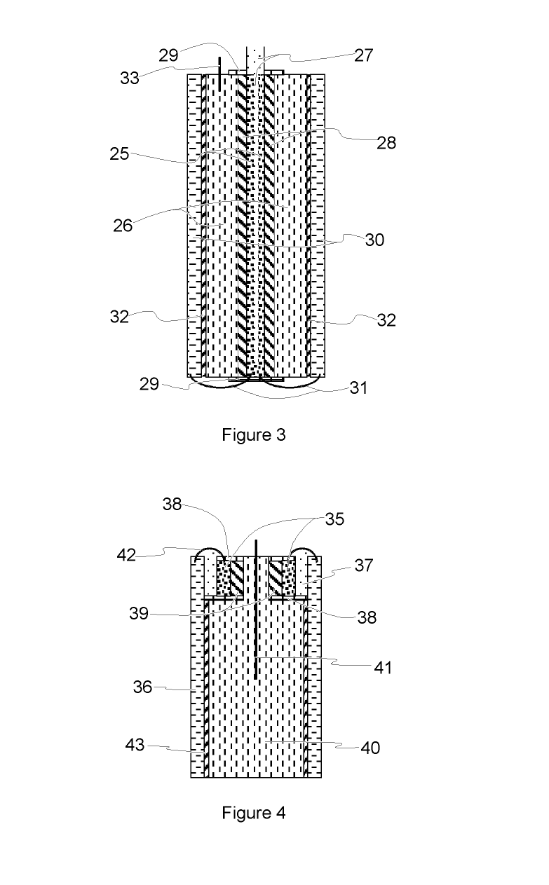

Another arrangement is shown in FIG. 3. In this arrangement the air cathode 25 is in a hole that extends through the center of the primary anode 26. The hole need not extend all the way through the assembly as shown. An air channel 27 runs into this hole. The electrolyte 28 within the cell is sealed within the hole between the cathode 25 and the primary anode 26 with one or more insulators 29 that also define a section of primary anode that may be consumed by the cell before leakage of the cell electrolyte occurs. The air cathode 25 is connected to the secondary anode 30 with elongated electron conducting conductors 31 such as wires or cables. The primary anode 26 is separated from the secondary anode 30 with a separator 32. Both primary 26 and secondary 30 anodes preferably include an activating agent. A connector 33 is connected to the primary anode 26 to facilitate connecting the assembly to a protected metal section.

A feature of the cell arrangement in FIG. 3 is the cell cathode 25 is at least in part spaced away from the secondary anode 30 by a section of the primary anode 26.

Another arrangement is shown in FIG. 4. In this arrangement the cell cathode 35 is an air cathode and spaced away from the secondary anode 36 by a gap 37 that at least includes air and acts as a channel for air to the cell cathode 35. Isolators 38 seal an electrolyte 39 in a cell formed between the cathode 35 and a distinct portion of the primary anode 40. The primary anode 40 is connected to a connector 41 to facilitate connection of the assembly to a protected metal section. Connectors 42, such as a metal wire, connect the cathode 35 to the secondary anode 36. The secondary anode 36 is separated from the primary anode 40 with a separator 43.

An air cathode is a beneficial feature because it occupies less volume than other cathodes. It is a fuel cell electrode with the fuel being oxygen from the air. The air cathode preferably has an airside that includes air, not dissolved, but as a gas. An air channel provided by, for example, a hydrophobic breathable fabric, may be used to improve the flow of fresh air to the air side of the cathode.

The main advantage of the arrangement in FIGS. 2 to 4 over that in the prior art of U.S. Pat. No. 8,273,239 is that air diffuses to the air side of an air cathode without having to pass through the cell electrolyte. The air reaches the air cathode before it dissolves in electrolyte. This allows the air cathode to support a higher current density. It also allows the cell to be constructed with a lower internal resistance through the electrolyte.

FIG. 5 shows one method using the sacrificial anode assemblies described above. An array of compact discrete anodes 45 is connected to the steel reinforcement 46 in concrete 47 via metal wire 48, such as an electric cable, connected to the connector of the assembly. The anodes may be connected to the steel either individually or as an array or string of anodes. In this example anodes with air cathodes are used and an air channel is provided to collect air for the air cathode within the cell of each assembly. The air channel 49 may be provided by a waterproofed but breathable fabric that is partly wrapped around the connecting wires 48.

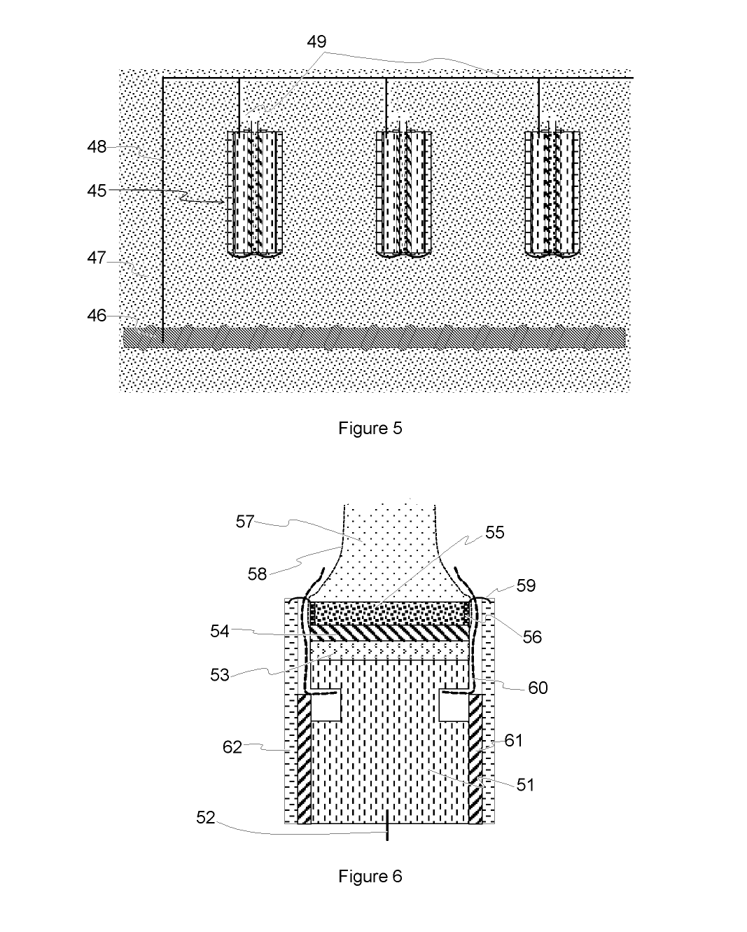

FIG. 6 shows a specific prototype of an anode assembly. In this example, a DuoGuard™ 350 anode was cut to shape to provide the zinc for the primary anode 51. The primary anode 51 included a connector 52. One of the surfaces of the primary anode 51 faced the cell of the assembly and formed part of the cell anode.

The cell anode was supplemented with a layer of zinc paste 53 from a Duracell® DA675N6 battery. Cotton wool saturated with 30% potassium hydroxide solution formed the cell electrolyte 54. The air cathode of a Duracell® DA675N6 and a section of the nickel coated metal from this cell that held the cathode in place was used to provide the cathode 55 of the cell and the metal 56 that held the cathode in place.

A woven nylon cloth was soaked in a water repellent material and then dried to provide the material for the air channel 57. The cloth was held against the air side of the air cathode 55 using a section of heat shrink insulation tubing 58. A hydrophobic water repellent material at this location prevents solution from entering this region to maintain the efficiency of the air cathode. Electron conducting connectors 59 were soldered to the metal 56 crimped to the air cathode. The cell was then held together and held onto one end of the primary anode with a further layer of adhesive lined heat shrink tubing 60.

Absorbent kitchen paper towel soaked in saturated sodium sulphate solution and then left to dry provided a separator 61 containing an activator (sodium sulphate) for the primary anode. A sheet of zinc taken from the casing of a zinc-carbon D sized cell was folded to form a secondary anode 62 around the primary anode 51 and separator 61. The connectors 59 were soldered to the secondary anode 62 to connect it to the cathode of the cell.

Soldered connections were used where necessary to form the assembly. All soldered connections were insulated with epoxy adhesive. Epoxy adhesive was used to insulate other components where necessary, including the edges of the metal crimped to the cathode, copper wires, and the outer surface of the primary anode in contact with the heat shrink tubing.

The cell of the assembly in FIG. 6 was discharged through a 500 Ohm resistor and it generated a current of between 2.2 and 0.2 mA over a period of 3 months.

One of the advantages of a cell with an air cathode as a power source is the high charge density of such cells. The charge densities expressed in milliamp hours per cubic centimeter may typically be at least 4 times higher for zinc-air cells (batteries) than the charge density in standard alkaline batteries. This allows much higher charge capacity units to be constructed for use in the relatively small holes of up to 50 mm in diameter drilled into concrete structures.

Cells occupy space in sacrificial anode assemblies which limits the charge capacity of the assembly in concrete structures. A typical AA sized alkaline cell has a rated charge capacity of 10 kC (2500 mA.hr) while a D sized alkaline cell has a rated capacity of about 60 kC (16000 mA.hr). An alkaline cell will typically have a charge density of between 130 and 230 mA.hr.cm-3.The use of higher charge density cells like the zinc air cell of about 770 to 1070 mA.hr.cm-3 facilitates the construction of composite cell/secondary anode assemblies where the assembly can fit into a drilled hole of up to 50 mm in diameter and the secondary anode of the assembly is a sacrificial anode with a charge capacity of at least 100 kC and preferably more than 150 kC.

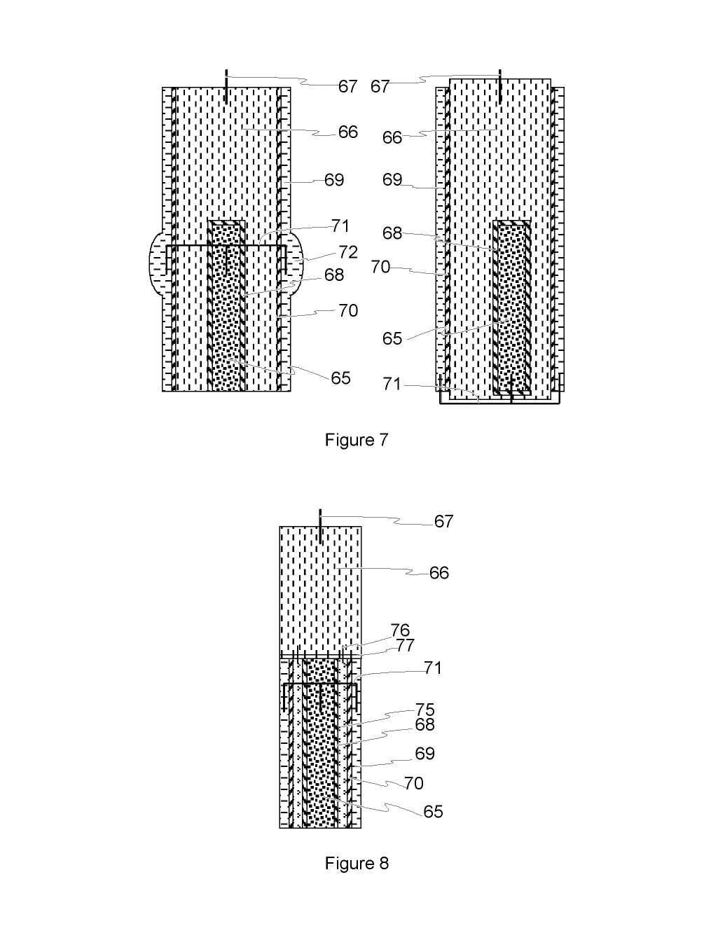

FIGS. 7 and 8 provide assemblies where cathodes other than air cathodes, such as manganese dioxide cathodes, may be used as part of the cell of the assembly. The shading is consistent for the components (primary anode, secondary anode, cathode, cell electrolyte, separator and in some cases cell anode (tertiary anode) where this is not provided by the primary anode) throughout the figures.

FIG. 7 shows two arrangements where a cathode 65, that might comprise manganese dioxide or any other suitable cathode material (examples include silver oxide and mercury oxide) is located in a cavity in the center of the primary anode 66. The primary anode includes a connector 67 for connecting the compact discrete assembly to a protected metal section. An internal surface of the primary anode is connected by an electrolyte 68 to the cathode 65 to form a cell. A secondary anode 69 comprising a sacrificial metal element is separated from the primary anode 66 by a separator 70 and activator for the primary anode 66. A connector 71, such as a metal wire, provides a path for the conduction of electrons from the secondary anode 69 to the cathode 65. This connector is insulated from the primary anode. In one example in FIG. 7, the secondary anode 69 has been thickened at a point 72 where the connector 71 is connected to the secondary anode to ensure a sustained connection and full utilization of the secondary anode as it corrodes away to provide protection current and ultimately expose the primary anode to the environment. The primary anode need not be exposed at all to the concrete environment until the secondary anode has been consumed and the secondary anode may completely surround the primary anode.

FIG. 8 shows an arrangement where the anode of the cell is not provided by the primary anode 66, but it is provided by a third or tertiary anode 75 which is any suitable cell anode, including for example, zinc or lithium. The assembly may also be split into two parts in which the cell and secondary anode is split from the primary anode 66. Additional connectors 76 connect the cell anode to the primary anode if it is to be assembled as a single unit in use. An isolating element 77 isolates other components of the cell and secondary anode including the secondary anode 69, separator 70, electrolyte 68 and cathode 65 from the primary anode. In this case the connector 71 that connects the cathode 65 to the secondary anode 69 is isolated from the tertiary anode 75.

In FIG. 8 the secondary anode 69 need not be a sacrificial anode that is consumed because the primary anode 66 would not need to deliver current through the secondary anode 69 at any point in time in this arrangement. The secondary anode 69 may instead be an inert electrode (e.g. a layer of carbon or activated titanium). The type of anode that might be used will to some extent depend on the voltage of the cell that provides a source of DC power in the assembly.

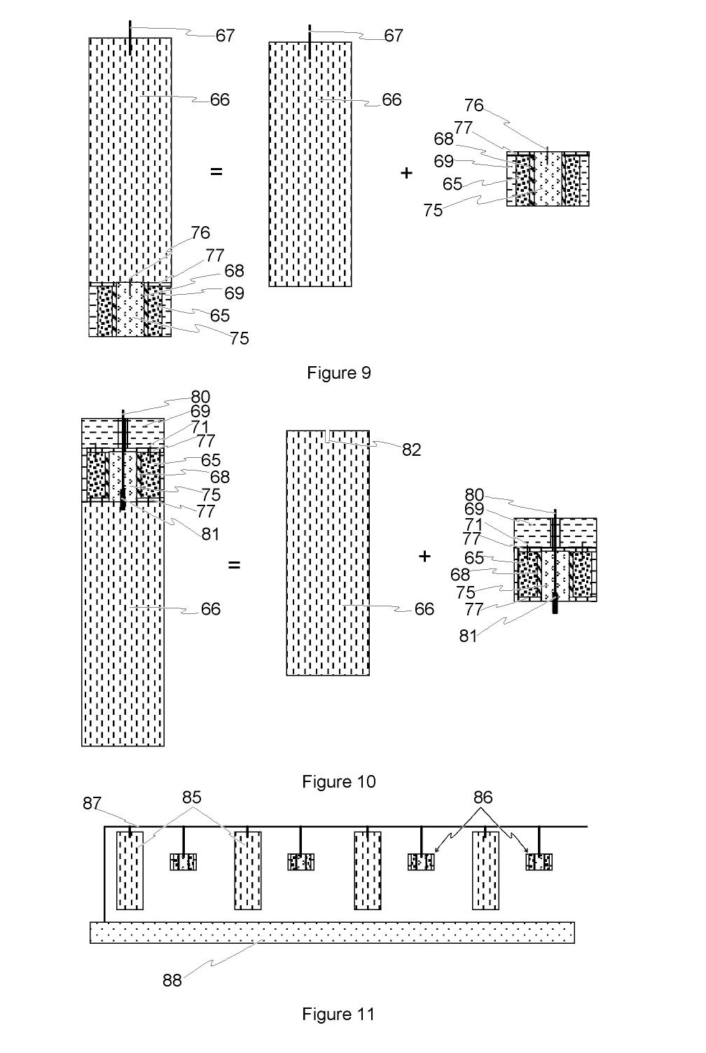

FIGS. 9 and 10 provide further examples of assemblies that may be split into two parts. The shading and numbering of the elements of the assembled and split assemblies is consistent with that of the previous Figures. Common elements include a cell cathode 65, a primary anode 66, a connector 67 to the primary anode for connecting the primary anode to the protected metal section, a cell electrolyte 68, a secondary anode 69, a connector 71 that connects the cathode to the secondary anode, a cell or tertiary anode 75 and isolating elements 77. It is preferable that the cell electrolyte is isolated from the environment.

In these Figures a tertiary anode or cell anode 75 is provided that can be separated from and connected to the primary anode 66. Insulating elements 77 are used to isolate other elements of the cell and secondary anode from the primary anode and the environment. The two parts may be assembled before use or connected with electron conductors such as metal wires after installation. These figures show both the assembled and split assemblies. One assembly comprises the primary anode with a connector or location at which a connector may be attached. The other assembly comprises a cell with its own cell anode, cell cathode and secondary anode. The shading and numbering of the elements of the assembled and unassembled assemblies is consistent with that of the previous Figures.

In FIG. 9, the cell cathode 65 is connected directly to the secondary anode 69, so avoiding the use of a distinct connector.

FIG. 10 shows yet another arrangement that may easily be split into 2 parts. In this arrangement the secondary anode 69 comprises an ingot of material. Such a block-like shape may be used to include a substantially higher quantity of charge in the secondary anode comprising a sacrificial metal element.

The connector 80 in FIG. 10 is a connector connected to both the tertiary (cell) 75 and primary 66 anodes and is insulated from the secondary anode 69 with an isolating element. The connector 80 includes element 81 such as a threaded rod that can be connected to an appropriate connection point 82 in the primary anode 66.

The primary anode provides the sustained galvanic protection current to maintain steel passivity. The primary anode preferably has a charge of at least 100 kC and more preferably 150 kC. The cell (or power supply) and secondary anode provides short term power in the form of more voltage and therefore more current to induce steel passivity. In the case where this is provided by an integrated cell and secondary anode assembly to be embedded within the concrete of a reinforced concrete structure, the useful life of the primary anode assembly will typically be substantially greater than the useful life the cell and secondary anode assembly. This difference will typically be a factor of 5 or more (the useful life of the primary anode element is five times that of the cell and secondary anode element).

FIG. 11 shows another method of arranging the components of the assemblies in use. In this example, the primary anode 85 is spaced away from the cell powered secondary anode 86. Electric cable or metal wire connectors 87 connect the components together and to the steel 88. The primary and cell powered secondary anode assemblies may either be connected together to form a string of connected components as shown, or the assemblies may be individually connected to the steel and indirectly connected to each other through the steel. The advantage of the arrangement in FIG. 11 is that current from the cell powered secondary anode 86 is more likely to flow to the steel 88 than to any exposed surface of the primary anode 85. This improves the efficiency of use of the limited capacity of a cell powered secondary anode.

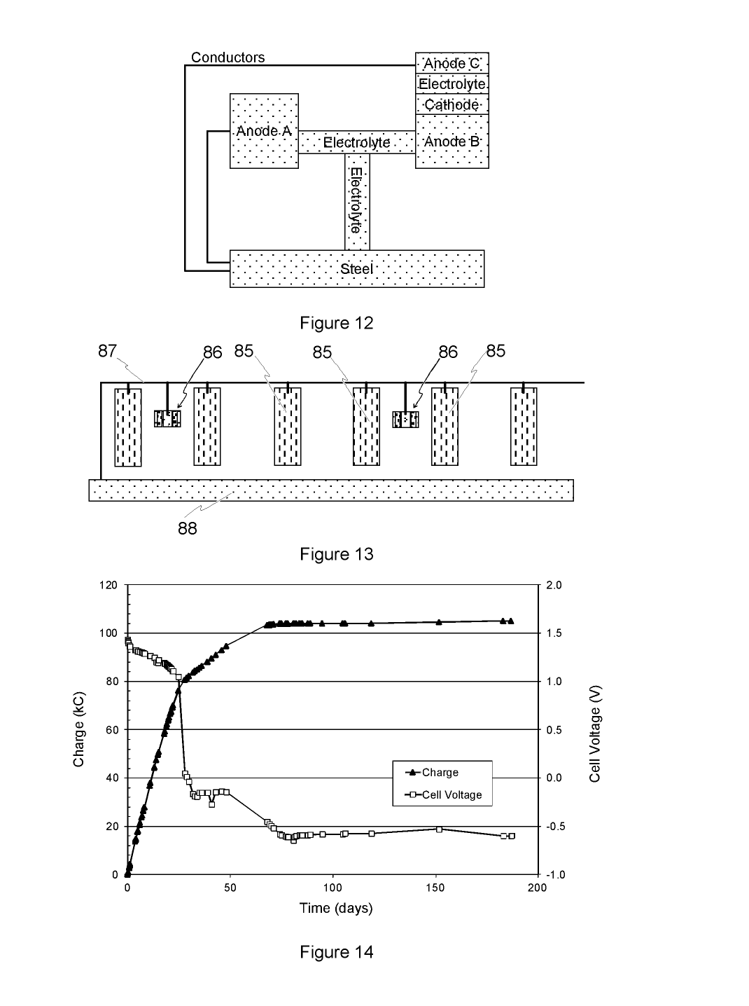

FIG. 12 is a block diagram showing the general connections in a protection system for a steel reinforced concrete element that has a separate tertiary or cell anode (Anode C). A primary sacrificial anode (Anode A) is connected to the steel by both electron conducting conductors and by an ionically conducting electrolyte (Electrolyte) to provide a long term sustained current. The cell (Anode C, Electrolyte and Cathode) powered secondary anode (Anode B) provides the power to arrest active corrosion and induce steel passivity typically at the start of the electrochemical treatment. These are also connected to the steel through conductors and electrolyte.

FIG. 13 shows another method of arranging the primary anode assemblies 85 and the cell powered secondary anode assemblies 86. Metal wire (e.g. electric cable) connectors 87 connect the components together and to the steel 88. The primary and cell powered secondary anode assemblies may either be connected together to form a string of connected components as shown, or the assemblies may be individually connected to the steel and indirectly connected to each other through the steel.

The high capacity of zinc-air cells and the beneficial impact of this on compact discrete cell and anode assemblies has been considered in the examples above. The high cell capacity allows the overall charge capacity of an integrated compact discrete cell and sacrificial anode assembly to be increased to values above 100 kC. By contrast, a 1.5 V alkaline D sized cell from a reputable manufacturer has a rated capacity of about 60 to 70 kC.

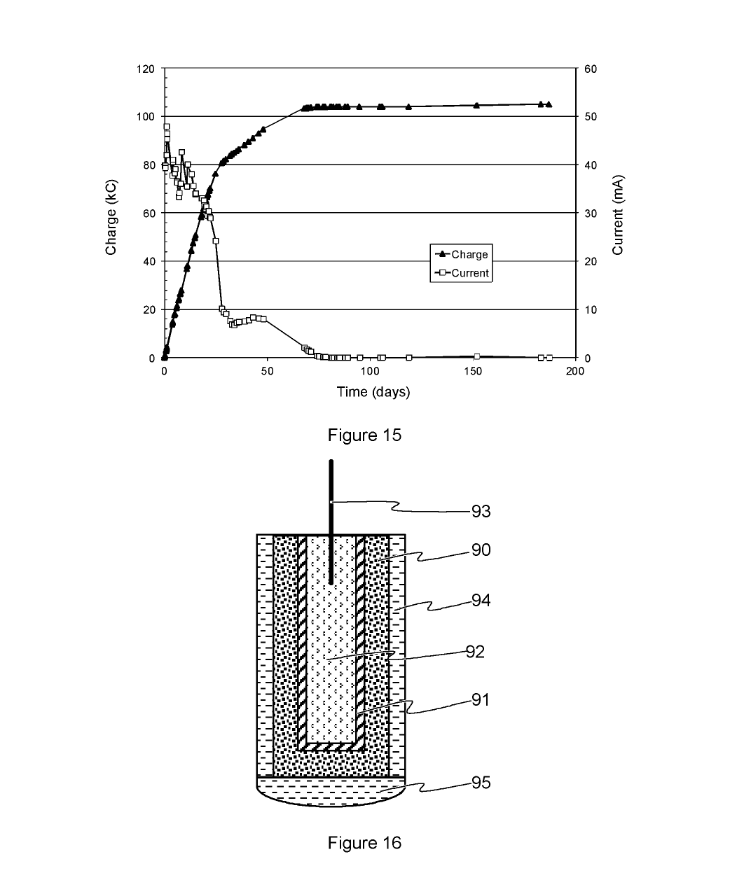

The discharge of a D-sized Duracell (®) 1.5 V alkaline battery connected in series with a DuoGuard™ D1000 anode and about 1 m2 of surface area of mild steel plate is shown in FIGS. 14 and 15. The D1000 anode and the steel plate were buried in a moist soil and the anode was embedded in a standard calcium sulphate/bentonite soil backfill to accelerate the cell discharge test.

FIG. 14 shows that after about 30 days, the polarity of the D-sized alkaline battery reversed. After 30 days, the cell no longer added any driving voltage to the natural galvanic potential difference between the sacrificial anode and the steel and indeed subtracted voltage from the galvanic potential difference. Nevertheless the charge that was delivered to the steel continued to rise for the next 45 days. Indeed more than 100 kC was delivered in total. FIG. 15 shows that galvanic protection current was delivered during this period.

The data in FIGS. 14 and 15 provides evidence that the capacity of a secondary sacrificial anode in a cell and secondary anode assembly may be more that 100 kC and more that 100 kC can be utilized. The capacity of a secondary sacrificial anode in a cell and secondary anode assembly is preferably more than 100 kC. It is preferably more than 125% of the charge capacity of the cell when the cell is an alkaline cell and may lie between 140% and 250% of the charge capacity of the cell when the cell is an alkaline cell or between 100 kC and 300 kC.

FIG. 16 provides a general arrangement in which for an integrated cell and sacrificial anode compact discrete assembly for installation in a hole drilled or cut into the concrete of reinforced concrete element of a concrete structure. The hole will typically be less than 50 mm in diameter. The cell could for example be a D-sized Duracell battery and the sacrificial anode could comprise zinc with a charge equivalent of 125 kC.

In FIG. 16 the cell comprises a cell cathode 90, electrolyte in cathode to anode separator 91, and a cell anode 92. The cell anode (tertiary anode) may for example be a paste of zinc particles and 30% potassium hydroxide solution. A connector 93 is connected to the cell anode for connecting the assembly to the protected metal section. A secondary sacrificial anode is attached to the cathode of the cell (for example by connecting it to the outer casing of a D-sized alkaline battery). This could comprise a sheet of zinc 94 wrapped around and soldered to the positive casing of the cell and an ingot of zinc in the form of a dome of zinc soldered to the positive end of the cell to make up a total charge equivalent of the secondary sacrificial anode of more than 100 kC.

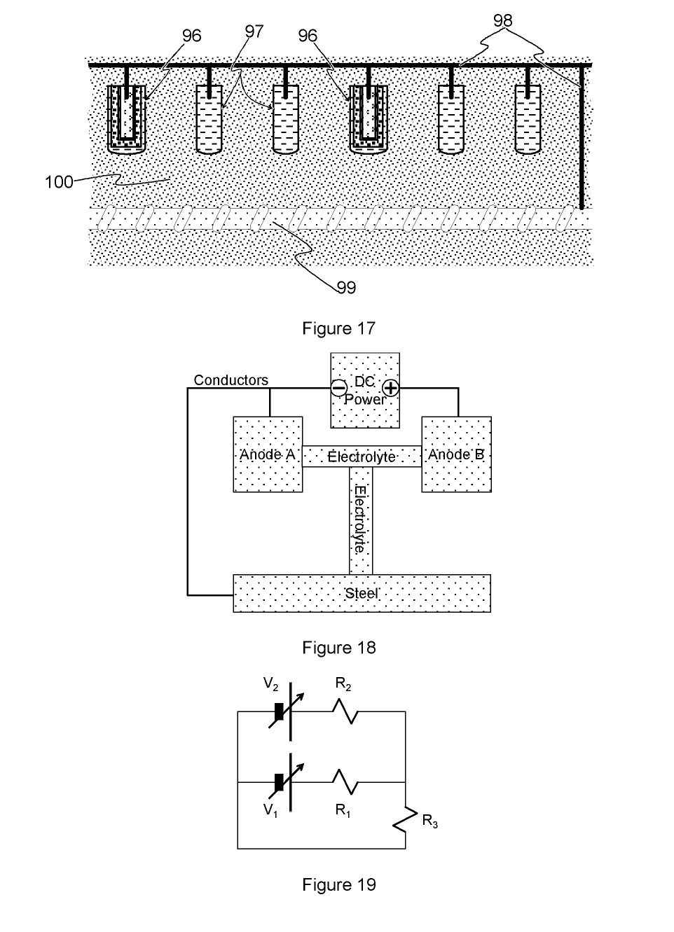

FIG. 17 shows one use of the integrated cell and sacrificial anode compact discrete assembly 96 disclosed in FIG. 16. In this use the cell and sacrificial anode assembly 96 is interspersed with unpowered primary sacrificial anode assemblies 97 and connected with conductors 98 to the steel 99 in an element of a concrete 100 structure.

In the above examples, the disclosed DC power supply is a cell. FIG. 18 shows a more general block diagram using any source of DC power. A primary sacrificial anode (Anode A) is connected to the steel (Steel) to deliver galvanic protection. A DC power supply (DC Power) is used to drive additional current off a secondary anode (Anode B) to deliver additional protection current when it is needed to for example arrest identified corrosion activity. In this arrangement powered and sacrificial systems are used together in the same reinforced concrete element. The powered system may be an anode assembly with its own integral power supply or it may be an external power supply such as those found in impressed current systems and in particular in temporary impressed current systems. When it is an external power supply, a single power supply may be connected to a plurality of secondary anodes. Additional power from an electrochemical protection system is often required when the structure is repaired to arrest ongoing active corrosion of the steel.

When systems are mixed as disclosed in FIG. 18, what may happen is the less powerful system fails to deliver any protection current and indeed it may take protection current from the more powerful system and away from the steel. The electric circuit corresponding to FIG. 18 is illustrated in FIGS. 19. V1 and V2 in FIG. 19 represent 2 anode systems with different voltages. R1 plus R2 represents the combined resistance through the electrolyte between the two anode systems an R3 represents the remaining resistance through the electrolyte to the steel. Assuming V1 is the less powerful system voltage and V2 is a value where no current flows through R1 then it can be shown that:

$$\frac{{V}_{2}}{{V}_{1}} = \frac{{R}_{2} + {R}_{3}}{{R}_{3}}$$

R1, R2 and R3 are to a first approximation proportional to distance and this provides a simple guide to design of a spaced layout of powered anodes and unpowered sacrificial anodes. Systems with variable power may therefore be combined in a reinforced concrete element avoiding current flow from one system directly to another system. A system comprising a spaced layout of powered anodes and unpowered galvanic anodes may also be designed such that the galvanic anodes deliver current to a much smaller area of steel when the powered anodes operate. Because the unpowered galvanic anodes deliver current to less steel, they effectively deliver more protection to that steel and are, in effect, also more powerful because the anode to steel area ratio is effectively changed by the action of the powered anodes.

While the invention has been described in connection with what is presently considered to be the most practical and preferred embodiments, it is to be understood that the invention is not limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A method of protecting steel in a reinforced concrete element, the reinforced concrete of the element containing an electrolyte, the method comprising:
providing at least one primary anode, wherein the at least one primary anode is a sacrificial anode;
providing at least one secondary anode, wherein the at least one secondary anode is connected to a positive terminal of at least one source of direct current, ‘DC’, power;
arranging the at least one primary anode and at least one secondary anode to have an ionic connection with the steel in the reinforced concrete element via the electrolyte;
connecting the at least one primary anode to the steel in the reinforced concrete element using an electron conductor;
connecting the negative terminal of the source of DC power to the steel in the reinforced concrete element using an electron conductor.

2. The method as claimed in claim 1 wherein, in said arranging step, each of at least one pair of primary anodes are provided on a different respective side of at least one secondary anode.

3. The method as claimed in claim 2 wherein, in said arranging step, each of at least one pair of primary anodes are provided on a different respective side of a plurality of secondary anodes.

4. The method as claimed in claim 1 wherein, in said arranging step, each of at least one pair of secondary anodes are provided on a different respective side of at least one primary anode.

5. The method as claimed in claim 1 wherein the number of primary anodes provided is greater than the number of secondary anodes.

6. The method as claimed in claim 1 wherein a plurality of primary anodes are provided and a single secondary anode is provided within a region of said reinforced concrete element.

7. The method as claimed claim 1 wherein, in said arranging step, said at least one primary anode is spaced from said at least one secondary anode at a distance of no more than substantially 2 meters within a 10% tolerance.

8. The method as claimed in claim 1 wherein, in said arranging step, said at least one primary anode and said at least one secondary anode are provided at a density of at least at least one primary anode and said at least one secondary anode per square meter of a surface of said reinforced concrete.

9. The method as claimed in claim 1 further comprising connecting each primary anode to the negative terminal of the source of DC power using at least one electron conductor other than the steel.

10. The method as claimed in claim 1 wherein the reinforced concrete element comprises an element of a larger concrete structure.

11. The method as claimed in any preceding claim claim 1 wherein each said secondary anode is a sacrificial anode.

12. The method as claimed in claim 1 wherein each said secondary anode is connected to a positive terminal of a respective source of DC power as part of an integrated anode assembly in which said secondary anode and said source of DC power are integrated to form a single unit.

13. The method as claimed in claim 1 wherein a plurality of secondary anodes are connected to a positive terminal of a single external source of DC power as part of an impressed current system.

14. A sacrificial anode reinforced concrete protection assembly for use in the method of claim 1, the assembly comprising:
a sacrificial anode for use as the secondary anode of said method, the sacrificial anode having a first charge capacity; and
a cell for use as the source of DC power of said method, the cell having a second charge capacity;
wherein the sacrificial anode is integrated with the cell as a single unit with the sacrificial anode connected to a positive terminal of the cell; and
wherein the first charge capacity is greater than the second charge capacity.

15. A sacrificial anode reinforced concrete protection assembly for use in the method of claim 1, the assembly comprising:
a sacrificial anode for use as the secondary anode of said method, the sacrificial anode having a first charge capacity; and
a cell for use as the source of DC power of said method, the cell having a second charge capacity;
wherein the sacrificial anode is integrated with the cell as a single unit with the sacrificial anode connected to a positive terminal of the cell; and
wherein the charge capacity of the sacrificial anode is substantially at least 100 kilo-Coulombs within a 10% tolerance.

16. A sacrificial anode reinforced concrete protection assembly for use in the method of claim 1, the assembly comprising:
a sacrificial anode for use as the secondary anode of said method; and
a cell for use as the source of DC power of said method, the cell having a cell anode forming a negative terminal, a cell cathode forming a positive terminal and a cell electrolyte ionic ally connecting the cell anode and the cell cathode;
wherein the sacrificial anode is integrated with the cell as a single unit with the sacrificial anode connected to the positive terminal of the cell; and
wherein the cell cathode comprises an air cathode, the air cathode having a first face substantially in contact with the cell electrolyte, and a second face substantially in contact with air.

17. A sacrificial anode reinforced concrete protection assembly for use in the method of any of claim 1, the assembly comprising:
a sacrificial anode for use as the secondary anode of said method; and
a cell for use as the source of DC power of said method, the cell having a cell anode forming a negative terminal, a cell cathode forming a positive terminal and a cell electrolyte ionically connecting the cell anode and cell cathode;
wherein the sacrificial anode is integrated with the cell as a single unit with the sacrificial anode connected to the positive terminal of the cell; and
wherein the cell cathode and the sacrificial anode are spaced away from one another but interconnected using at least one electron conducting wire.

18. A sacrificial anode reinforced concrete protection assembly comprising:
a primary anode, wherein the primary anode is a sacrificial anode;
a secondary anode, wherein the secondary anode is a sacrificial anode; and
a cell, the cell having a cell anode forming a negative terminal, a cell cathode forming a positive terminal and a cell electrolyte ionically connecting the cell anode and the cell cathode;
wherein the primary anode and the secondary anode are integrated with the cell as a single unit with the secondary anode connected to the positive terminal of the cell.

19. The assembly as claimed in claim 18 wherein the primary anode is positioned between the secondary anode and the cell.

20. The assembly as claimed in claim 18 wherein the primary anode is connected to the negative terminal of the cell.

21. The assembly as claimed in claim 18, wherein the primary anode and cell anode are formed from a common piece of sacrificial material.

22. The assembly as claimed in claim 18, wherein the primary anode and cell anode are formed from different pieces of sacrificial material.

23. The assembly as claimed in claim 14 wherein the cell comprises a cell anode forming a negative terminal, a cell cathode forming the positive terminal and a cell electrolyte ionically connecting the cell anode and the cell cathode.

24. The assembly as claimed in any of claims claims 14 comprising a further anode, wherein the further anode is a sacrificial anode; wherein the further anode and the secondary anode are integrated with the cell as a single unit with the secondary anode connected to the positive terminal of the cell.

25. The assembly as claimed in claim 17, wherein the cell cathode comprises an air cathode, the air cathode having a first face substantially in contact with the cell electrolyte, and a second face substantially in contact with air.

26. The assembly as claimed in claim 16, wherein the cell cathode and the sacrificial anode of the secondary anode are spaced away from one another but interconnected using at least one electron conducting wire.

27. The assembly as claimed in claim 16 wherein the sacrificial anode of the secondary anode has a first charge capacity and the cell has a second charge capacity and wherein the first charge capacity is greater than the second charge capacity.

28. The assembly as claimed in claim 14 wherein the charge capacity of the sacrificial anode is substantially no less than 1.25 times the charge capacity of the cell within in a 10% tolerance.

29. The assembly as claimed in claim 14, wherein the charge capacity of the sacrificial anode of the secondary anode is substantially at least 100 kilo-Coulombs within a 10% tolerance.

30. The assembly as claimed in the claim 29 wherein the charge capacity of the sacrificial anode of the secondary anode is substantially at least 150 kilo-Coulombs within a 10% tolerance.

31. The method as claimed in claim 7 wherein, in said arranging step, said at least one primary anode is spaced from said at least one secondary anode at a distance of no more than substantially 1 meter within a 10% tolerance.

32. The method as claimed in claim 32 wherein, in said arranging step, said at least one primary anode is spaced from said at least one secondary anode at a distance of no more than substantially 600 mm within a 10% tolerance.

33. The method as claimed in claim 8 wherein, in said arranging step, said at least one primary anode and said at least one secondary anode are provided at a density of at least at least two primary anodes and said at least one secondary anode per square meter of a surface of said reinforced concrete.
